(19) United States
(12) Patent Application Publication
(10) Pub. No.: US 2025/0286417 A1
(43) Pub. Date: Sep. 11, 2025

(54) FIELD ELEMENT, AND ROTOR AND ROTARY ELECTRICAL MACHINE EQUIPPED WITH SAME

(71) Applicant: MAGNATURE, INC., Tokyo (JP)

(72) Inventors: Shuichi YOKOYAMA, Tokyo (JP); Shengyang HUANG, Tokyo (JP); Shigeo HATATANI, Tokyo (JP)

(73) Assignee: MAGNATURE, INC., Tokyo (JP)

(21) Appl. No.: 18/270,929

(22) PCT Filed: Dec. 27, 2021
(86) PCT No.: PCT/JP2021/048582

§ 371 Date: Jul. 5, 2023

(30) Foreign Application Priority Data
Jan. 7, 2021 (JP) 2021-001724
Mar. 30, 2021 (JP) 2021-058156

(51) Int. Cl. H02K 1/2783; H02K 1/28; H02K 3/47; H02K 21/14

(52) U.S. Cl. CPC H02K 1/2783; H02K 1/28; H02K 3/47; H02K 21/14

(57) ABSTRACT

A Halbach motor includes a coupling structure to transmit rotational torque of a field element to a shaft. The field element includes a first group and a second group each of which includes a plurality of unit permanent magnets arranged adjacent to one another, first magnets constituting the first group are formed of unit permanent magnets repelling each other, second magnets constituting the second group are formed of unit permanent magnets attracting each other, and a recessed step portion is formed on an end surface of the first group and the second group by the first group and the second group being displaced forward and backward in the axial direction with respect to each other. The coupling structure includes a plurality of recessed step portions of the field element and teeth forming a plurality of protruding portions arranged opposite to the recessed step portions in the axial direction.

### TECHNICAL FIELD

The present invention relates to a rotary electrical machine, and in particular to a torque transmission technology in a rotor including a Halbach field element.

### BACKGROUND ART

A method for arranging unit permanent magnets constituting a field element in which, in a rotary electrical machine (a motor or a generator), a plurality of unit permanent magnets are arranged in accordance with a magnet array referred to as a Halbach array in order to enhance a magnetic field has been known.

Specifically, in the case of an N-S array in which a plurality of unit permanent magnets are arranged in such a way that N-poles and S-poles are simply alternately arranged, the magnetic field cannot be effectively used because magnetic fields are generated on both the front side and the back side of the magnet array.

In contrast, in the Halbach array, a plurality of unit permanent magnets are successively arranged while rotating the magnetic poles of the unit permanent magnets by a predetermined angle (for example, 90°). Because of this configuration, the strength of the magnetic field on one side of the magnet array is decreased and the strength of the magnetic field on the other side of the magnetic array is increased, and it is thus possible to generate a strong magnetic field on one side of the magnet array (see, for example, PTL 1).

### CITATION LIST

### Patent Literature

PTL 1: JP 2015-142484 A (Paragraph 0025)

### SUMMARY OF INVENTION

### Technical Problem

In the technology described in PTL 1, fixation of unit permanent magnets to a rotor is performed by, after temporarily fixing all the unit permanent magnets to the circumference of a rotor core with an adhesive agent, fitting ring members for magnet fixation into notches on both ends of the unit permanent magnets.

However, when such a fixation method is employed, even if flying-off, abrasion, damage, or the like of the unit permanent magnets due to centrifugal force at the time of rotation or magnetic acting force can be prevented, there is room for improvements as a structure to securely transmit essential rotational torque because fixation means between the rotor core and the unit permanent magnets is radial restraining force exerted by the adhesive agent and the ring members.

In addition, although, if a fitting structure using splines, serrations, or the like is disposed between the outer circumferential surface of the rotor core and the inner circumferential surface of the unit permanent magnets, a structure to transmit rotational torque can be incorporated, adding such a structure to the unit permanent magnets or incidental members causes not only the structure to become complex and a cost to be increased but also productivity to be reduced.

Accordingly, the present invention has been made focusing on the problem described above, and an object of the present invention is to provide a field element and a rotor and a rotary electrical machine including the rotor that, in the rotor including a Halbach field element, enable torque to be securely transmitted to a shaft with a simple structure.

### Solution to Problem

In order to achieve the above-described object, according to an aspect of the present, there is provided a field element including a plurality of unit permanent magnets arranged in a cylindrical shape in a circumferential direction to form a Halbach array, wherein the plurality of unit permanent magnets include a first group including a plurality of the unit permanent magnets arranged adjacent to one another and a second group including a plurality of the unit permanent magnets, the unit permanent magnets being the unit permanent magnets other than the first group and being arranged adjacent to one another, first magnets constituting the first group are formed of unit permanent magnets repelling each other, second magnets constituting the second group are formed of unit permanent magnets attracting each other, and the first group and the second group are displaced forward and backward in an axial direction with respect to each other and a step portion is formed on an axial end surface of the first group and the second group.

According to the field element according to the one aspect of the present invention, since a step portion is formed on an end surface of the first group and the second group by the first group and the second group being displaced forward and backward in the axial direction with respect to each other, when a recessed portion or a protruding portion that is arranged opposite to the step portion in the axial direction is disposed, torque can be transmitted through fitting between the stage portion and the recessed portion or the protruding portion. Therefore, when a rotor is configured using the field element according to the one aspect of the present invention, it becomes possible to securely transmit torque to the shaft with a simple structure.

In addition, in order to achieve the above-described object, according to an aspect of the present, there is provided a rotor including: the field element according to the aspect of the present invention; a shaft arranged at a center of the field element along an axial direction; and a coupling structure configured to transmit rotational torque of the field element to the shaft, wherein the coupling structure includes a plurality of recessed step portions formed by the first groups and the second groups of the plurality of unit permanent magnets being displaced forward and backward in an axial direction with respect to each other and a plurality of protruding portions arranged opposite to the plurality of recessed step portions in the axial direction and transmits the torque through fitting between the plurality of recessed step portions and the plurality of protruding portions.

In addition, in order to achieve the above-described object, according to an aspect of the present, there is provided a rotary electrical machine including: a rotor including a field element configured including a structure in which a plurality of unit permanent magnets are arranged in a cylindrical shape; an armature arranged in such a manner as to surround a circumference of the rotor; and a housing configured to house the rotor and the armature, wherein the rotary electrical machine includes, as the rotor, the rotor according to the aspect of the present invention.

According to the rotor and the rotary electrical machine including the rotor according to the one aspect of the present invention, since the rotor includes the coupling structure to transmit rotational torque of the field element to the shaft and, in the coupling structure, step portions can be formed on an end surface of the field element because of an operational effect of the field element according to the one aspect of the present invention, it is possible to transmit torque through fitting between the step portions and the protruding portions arranged opposite to the step portions in the axial direction. Therefore, it is possible to securely transmit torque of the field element to the shaft with a simple structure.

Furthermore, in order to achieve the above-described object, according to an aspect of the present, there is provided a field element including a plurality of unit permanent magnets arranged in a cylindrical shape in a circumferential direction, wherein at least some of pairs of the unit permanent magnets adjacent to each other are arranged in such a manner as to be displaced forward and backward in an axial direction with respect to each other.

According to the field element according to the another aspect of the present invention, since at least some of pairs of the unit permanent magnets adjacent to each other are arranged in such a manner as to be displaced forward and backward in the axial direction with respect to each other, it is possible to form a plurality of recessed portions on an end surface of the field element. Therefore, when a plurality of protruding portions that are arranged opposite to the recessed portions in the axial direction are disposed, it is possible to transmit torque through fitting between the plurality of recessed portions and the plurality of protruding portions. Therefore, when a rotor is configured using the field element according to the another aspect of the present invention, it becomes possible to securely transmit torque to the shaft with a simple structure.

In addition, in order to achieve the above-described object, according to an aspect of the present, there is provided a rotor including: a field element including a plurality of unit permanent magnets arranged in a cylindrical shape in a circumferential direction; a shaft arranged at a center of the field element along an axial direction; and a coupling structure configured to transmit rotational torque of the field element to the shaft, wherein the coupling structure includes a plurality of recessed portions formed by at least some of pairs of the unit permanent magnets adjacent to each other being arranged in such a manner as to be displaced forward and backward in the axial direction with respect to each other and a plurality of protruding portions arranged opposite to the plurality of recessed portions in the axial direction and transmits the torque through fitting between the plurality of recessed portions and the plurality of protruding portions.

In addition, in order to achieve the above-described object, according to an aspect of the present, there is provided a rotary electrical machine including: a rotor including a field element configured including a structure in which a plurality of unit permanent magnets are arranged in a cylindrical shape; an armature arranged in such a manner as to surround a circumference of the rotor; and a housing configured to house the rotor and the armature, wherein the rotary electrical machine includes, as the rotor, the rotor according to the aspect of the present invention.

According to the rotor and the rotary electrical machine including the rotor according to the another aspect of the present invention, the rotor includes the coupling structure to transmit rotational torque of the field element to the shaft, and the coupling structure includes a plurality of recessed portions formed by at least some of pairs of unit permanent magnets adjacent to each other being arranged in such a manner as to be displaced forward and backward in an axial direction with respect to each other and a plurality of protruding portions arranged opposite to the plurality of recessed portions in the axial direction and is capable of transmitting torque through fitting between the plurality of recessed portions and the plurality of protruding portions. Therefore, it is possible to securely transmit torque of the field element to the shaft with a simple structure.

### Advantageous Effects of Invention

As described above, the present invention enables torque of a field element to be securely transmitted to a shaft with a simple structure.

### BRIEF DESCRIPTION OF DRAWINGS

FIG. 1 is a perspective view of a Halbach motor that is one embodiment of a rotary electrical machine according to one aspect of the present invention and the drawing is illustrated with a portion of the Halbach motor broken away along the axial direction;

FIG. 2 is an explanatory diagram illustrative of the Halbach motor in FIG. 1 broken away along the axial direction;

FIG. 3 is a perspective view descriptive of one embodiment of a unit permanent magnet (having trapezoidal end surfaces) constituting a field element of the Halbach motor in FIG. 1;

FIGS. 4A and 4B are perspective views descriptive of another embodiment of the unit permanent magnet (FIG. 4A illustrates a unit permanent magnet having sectoral end surfaces and FIG. 4B illustrates a unit permanent magnet having end surfaces shaped by combining a trapezoid and a sector) constituting the field element of the Halbach motor in FIG. 1;

FIG. 5A is a perspective view illustrative of the field element of the Halbach motor in FIG. 1 and FIG. 5B is a schematic diagram descriptive of an arrangement of unit permanent magnets of the field element;

FIG. 6 is an exploded perspective view descriptive of the field element and a rotor including the field element of the Halbach motor in FIG. 1;

FIG. 7 is a schematic developed view descriptive of an arrangement and axial lengths of the unit permanent magnets and the drawing also illustrates corresponding magnet numbers and directions of magnetic poles;

FIG. 8 is a graph descriptive of a relationship between the direction of electromagnetic force (θ-component) corresponding to the magnet number of each unit permanent magnet and the direction of electromagnetic force (θ-component) corresponding to another adjacent magnet number;

FIG. 9 is a schematic developed view descriptive of another example of an arrangement and axial lengths of the unit permanent magnets and the drawing also illustrates corresponding magnet numbers and directions of magnetic poles;

FIG. 10A is a perspective view illustrative of a field element of a Halbach motor of another embodiment and FIG. 10B is a schematic diagram descriptive of an arrangement of unit permanent magnets of the field element; and

FIG. 11 is an exploded perspective view descriptive of the field element and a rotor including the field element of the Halbach motor of the another embodiment.

### DESCRIPTION OF EMBODIMENTS

An embodiment of the present invention will be described below with reference to the drawings as appropriate. Note that the drawings are schematic. Therefore, it should be noted that relations between thicknesses and planar dimensions, ratios, and the like are different from actual ones and portions having different dimensional relationships and ratios from one another among the drawings are included.

In addition, the following embodiment indicates devices and methods to embody the technical idea of the present invention by way of example, and the technical idea of the present invention does not limit the materials, shapes, structures, arrangements, and the like of the constituent components to those described below.

### Rotary Electrical Machine

First, a Halbach motor that is one embodiment of a rotary electrical machine including a Halbach field element will be described. In the present embodiment, a Halbach motor configured as a three-phase synchronous motor will be described as an example of the rotary electrical machine.

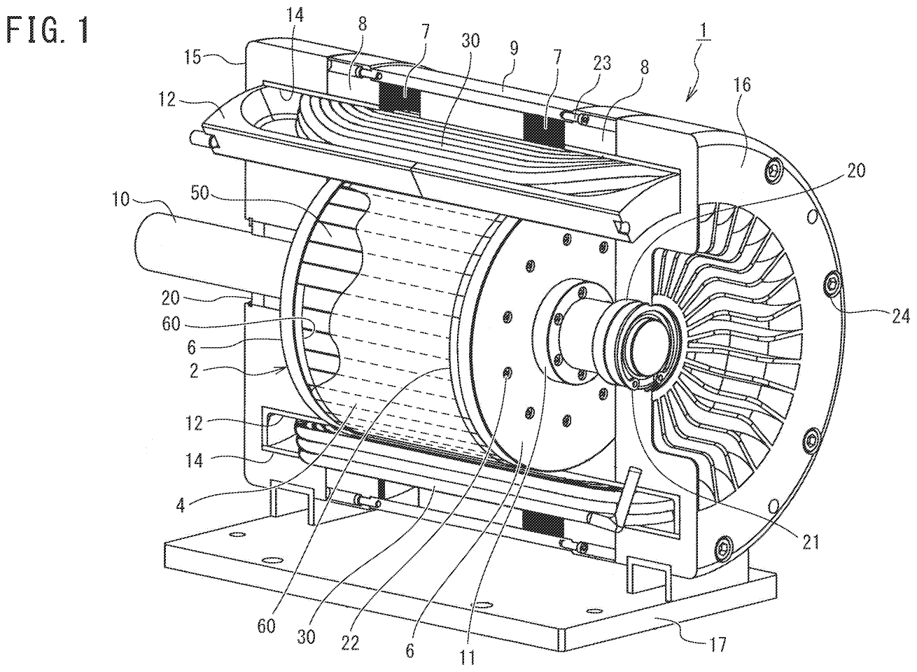

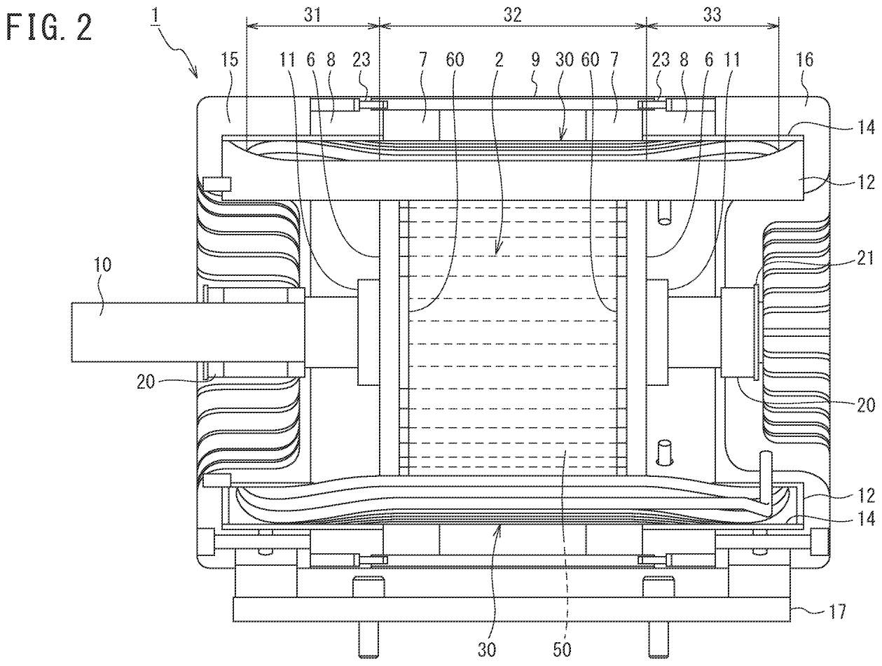

As illustrated in FIGS. 1 and 2, a Halbach motor 1 of the present embodiment includes a cylindrical Halbach field element 2 (hereinafter, also simply referred to as “field element”) that is configured including a structure in which a plurality of unit permanent magnets 50 are arranged in a cylindrical shape and coil holders 12 in which three armature windings 30 are respectively housed in such a manner as to be arranged opposite to an outer circumferential surface of the field element 2 in the radial direction. The Halbach motor 1 is mounted on an installation target with a lower portion thereof supported by a base 17.

On a surface facing the outer peripheral side of each of the coil holders 12, an elliptical recessed portion to house an armature winding 30 is formed. The elliptical recessed portion of each of the coil holders 12 is covered by a coil holder cover 14 after an armature winding 30 is housed therein.

The coil holders 12 are held at positions spaced an appropriate clearance away from the outer circumferential surface of the field element 2 by a pair of housings 15 and 16 that are disposed to be separated from each other at the front and rear in the axial direction. Between the pair of housings 15 and 16, a plurality of yokes 7 each of which is formed of an electromagnetic steel sheet are arranged.

The plurality of, for example, 500, yokes 7 are stacked in a cylindrical shape along the circumferential direction, and the outer side of the plurality of yokes 7 is supported by a cylindrical outer yoke 9 and the plurality of yokes 7 are also supported by a pair of yoke pressers 8 from the front and rear sides in the axial direction.

At the center of the field element 2, a shaft 10 that serves as an input shaft or an output shaft of the rotary electrical machine is fixed in a coaxial manner. In the present embodiment, to the shaft 10, a pair of shaft flanges 11 are disposed separated from each other at the front and rear thereof in the axial direction.

On both sides in the axial direction of the plurality of unit permanent magnets 50, a pair of disk-shaped field element end holders (end face covers, hubs, or wheels) 6 are mounted. At a central portion of each field element end holder 6, one of the shaft flanges 11 is fixed in such a manner that the shaft 10 penetrates the field element end holder 6 in the axial direction.

The pair of shaft flanges 11 are fixed on the outer side surfaces of the field element end holders 6 at the front and rear in the axial direction by a plurality of holder fixing bolts 22, and, because of this configuration, the field element end holders 6 and the shaft 10 are integrated with each other. The shaft 10 is supported in a freely rotatable manner by combination bearings 20 that are respectively disposed at central portions of the pair of housings 15 and 16 and, at the same time, has the position thereof in the axial direction defined by the rear end thereof being held to the rear housing 16 by a C-type retaining ring 21.

The three armature windings 30 of the present embodiment are air-core coils each of which forms an oval shape in plan view and are formed in a curved shape along the circumferential direction. At a central portion of each of the coil holders 12, a rectangular protruding portion is formed, and a cavity portion at the center of an air-core coil being fitted on the outer circumferential surface of the protruding portion causes an armature winding 30 to be securely held at an expected mounting position.

The three armature windings 30 are connected to one another at winding start terminals of the respective armature windings 30, and the connection point serves as a neutral point. Note that a wiring for measurement is connected to the neutral point and is extended to the outside of the machine. To winding end terminals of the respective armature windings 30, three phases of three-phase AC are configured to be respectively applied.

In the Halbach motor 1 of the present embodiment, NS magnetic fields of the quadrupole field element 2 being attracted to moving magnetic field that is generated by flowing in sequence the U-phase, V-phase, and W-phase AC currents that are temporally delayed from one another by 120° to the three armature windings 30 causes the field element 2 to synchronize with the three-phase AC current and thereby enables the Halbach motor 1 to rotate at a rotation speed matching the frequency of the three-phase AC current.

### Halbach Field Element and Rotor Including the Same

Next, the above-described Halbach field element 2 and a rotor including the Halbach field element 2 will be described in more detail. Note that, when, in the description of the present invention, a plurality of unit permanent magnets are referred to without distinguishing the unit permanent magnets from one another, the plurality of unit permanent magnets are denoted by a representative reference sign 50.

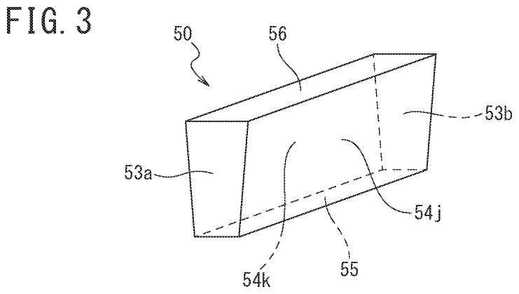

In the field element 2 of the present embodiment, as illustrated in a perspective view in FIG. 3, each of the plurality of unit permanent magnets 50 has a predetermined hexahedral shape. The form of the hexahedral shape of the present embodiment is a quadrangular prism shape the two surfaces 53a and 53b of which at both axial ends are trapezoidal shapes that are parallel and congruent with each other and all the other surfaces 54j, 54k, 55, and 56 of which form parallelogram shapes extending in the axial direction.

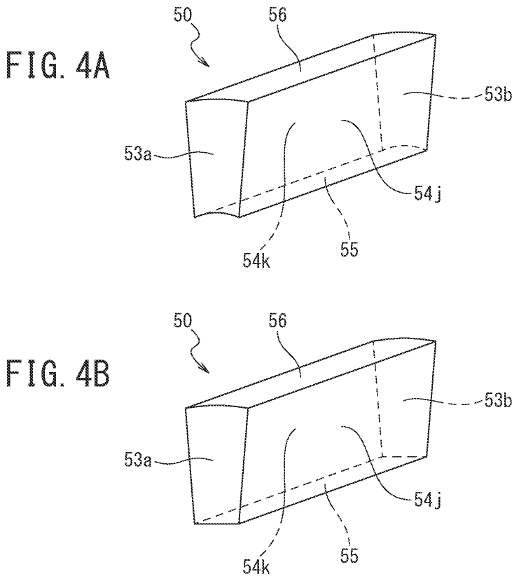

However, as the predetermined hexahedral shape of each unit permanent magnet 50, as illustrated in FIG. 3, FIG. 4A or FIG. 4B, a three-dimensional shape the two surfaces 53a and 53b of which at both axial ends are rectangles (FIG. 3), sectors (FIG. 4A), or shapes formed by combining a rectangle and a sector (FIG. 4B) that are parallel and congruent with each other and the other four surfaces 54j, 54k, 55, and 56 of which extending in the axial direction are formed in flat surfaces or curved surfaces each of which extends along opposing outlines of the two surfaces 53a and 53b at both axial ends can be employed.

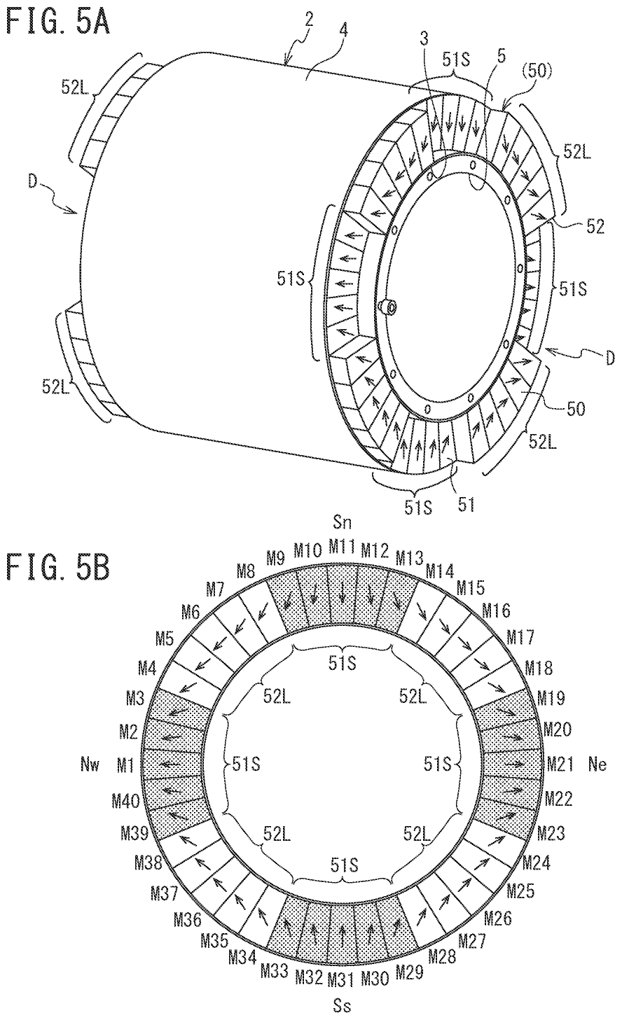

The field element 2 of the present embodiment is a field element that has a quadrupole NS magnetic field structure in which a plurality of (in this example, 40) unit permanent magnets 50, each of which is formed in the above-described hexahedral shape, are combined in the circumferential direction into a cylindrical shape with the axes of the unit permanent magnets 50 aligned parallel with one another and are arranged in a Halbach array, as illustrated in FIGS. 5A and 5B. When a rotor is configured, the above-described shaft 10 is arranged at the center of the field element 2 along the axial direction.

In the Halbach array, it is preferable that any one of numbers each of which is obtained by adding 2 to a multiple of 3 be defined as a division number for dividing one cycle of electrical angle and unit permanent magnets 50 the magnetization directions of which are successively changed by an angle obtained by dividing one cycle of electrical angle by the division number be arranged. In this case, cross-sectional shapes parallel with all the magnetization directions of the unit permanent magnets 50 are the same.

The plurality of unit permanent magnets 50 the magnetic directions of which are differentiated between unit permanent magnets 50 adjacent to each other are combined into a cylindrical shape in such a way as to be arranged in a predetermined Halbach array. Note that, in FIGS. 5A and 5B, an arrow illustrated on an end surface of each unit permanent magnet 50 indicates an image of a magnetic direction that the unit permanent magnet 50 has and the base end side and the tip end side of the arrow are the S-pole and the N-pole, respectively.

With regard to the magnetization directions in the Halbach field element 2 of the present embodiment, for example, two unit permanent magnets are arranged as unit permanent magnets for S-pole portions, two unit permanent magnets are arranged as unit permanent magnets for N-pole portions, and four sets of unit permanent magnets each of which includes nine types of unit permanent magnets are respectively arranged in four Halbach transition portions, as illustrated in FIG. 5B. For this reason, to assemble one field element 2, 40 unit permanent magnets 50 of eleven types in total are required.

In the present embodiment, since the cross-sectional shapes parallel with all the magnetization directions of the unit permanent magnets 50 are the same, the Halbach array of the field element 2 is configured by a set of 40 unit permanent magnets 50 the magnetization directions of which are successively changed by 18°. In the description of the present invention, for the purpose of describing a relative relationship among the four poles arranged in a Halbach array, when one of the S-poles is positioned at the top, the position of the S-pole is denoted by a reference sign Sn, the S-pole located on the opposite side thereto is denoted by a reference sign Ss, an N-pole located on the right-hand side is denoted by a reference sign Ne, and the other N-pole located on the left-hand side is denoted by a reference sign Nw, as illustrated in FIG. 5B.

In a process of technology development of, for example, the technology described in PTL 1, when a field element having a quadrupole Halbach array is manufactured, 40 unit permanent magnets of 11 types in total are required, as described in PTL 1. In contrast, with regard to the field element 2 of the present embodiment, a field element in which unit permanent magnets are arranged in a Halbach array is manufactured by producing in advance unit permanent magnets that are classified into a plurality of types that can constitute a Halbach array, binding such unit permanent magnets in a predetermined arrangement, and maintaining the arranged state.

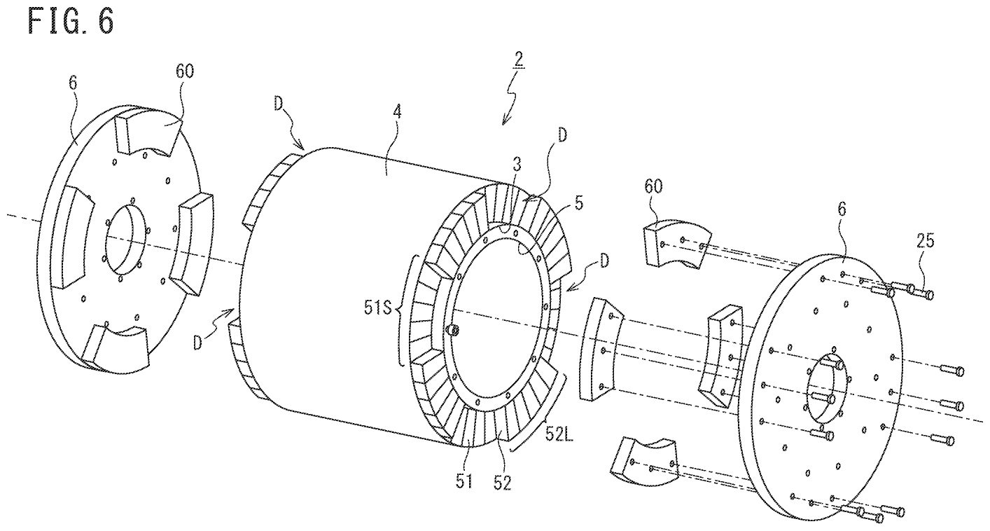

That is, the field element 2 of the present embodiment is configured by a thin-walled cylindrical field element inner holder 3 being fitted to the radially inner side of an annular row of a plurality of unit permanent magnets 50 and a thin-walled cylindrical field element outer holder 4 being also fitted to the radially outer side thereof in a coaxial manner, as illustrated in FIGS. 5 and 6. The field element inner holder 3 and the field element outer holder 4 are formed of carbon fiber reinforced plastics (CFRP). Because of this configuration, in the field element 2 of the present embodiment, a state in which the plurality of unit permanent magnets 50 that constitute a Halbach field element are combined into a cylindrical shape is maintained.

In the rotor of the present embodiment, an inner yoke 5 made of aluminum is fitted on the inner circumferential surface of the field element inner holder 3 in a coaxial manner and the pair of field element end holders 6 illustrated in FIG. 1 are fixed at the front and rear in the axial direction of the field element by screwing a plurality of holder fixing bolts 22 into fixed female screw portions on the end surfaces of the inner yoke 5.

The rotor of the present embodiment includes a coupling structure to transmit rotational torque of the field element 2 to the shaft 10.

The coupling structure of the present embodiment includes a plurality of recessed portions D that are formed on the end surfaces of adjacent unit permanent magnets 50 and teeth 60 that form a plurality of protruding portions arranged opposite to the plurality of recessed portions D in the axial direction, as illustrated in an exploded perspective view in FIG. 6 and is configured to transmit rotational torque through fitting between the plurality of recessed portions D and the plurality of teeth 60. The coupling structure of the present embodiment will be described in detail below.

Each tooth 60 is made of a non-magnetic material (for example, made of stainless steel), and the plan-view shape of the tooth 60 is a similar figure to the end surface of a group including unit permanent magnets 50. In the rotor of the present embodiment, on the axially inner side surfaces of the pair of field element end holders 6, a plurality of teeth 60 are fixed by tooth fixing bolts 25.

Note that, for each tooth 60, various types of non-magnetic materials without being limited to stainless steel can be employed. Plastics may be employed. It is suitable to use lightweight aluminum alloy or plastics as a material of each tooth 60 in order to configure a lightweight, low-inertia rotor.

In the field element 2 of the present embodiment, among the 40 unit permanent magnets 50 constituting a predetermined Halbach array, sets of five magnets adjacent to one another at the positions of the four poles are referred to as first groups 51S and, at the same time, sets of five magnets adjacent to one another in the transition portions located between pairs of adjacent poles among the four poles are referred to as second groups 52L, as illustrated in FIGS. 5A and 5B.

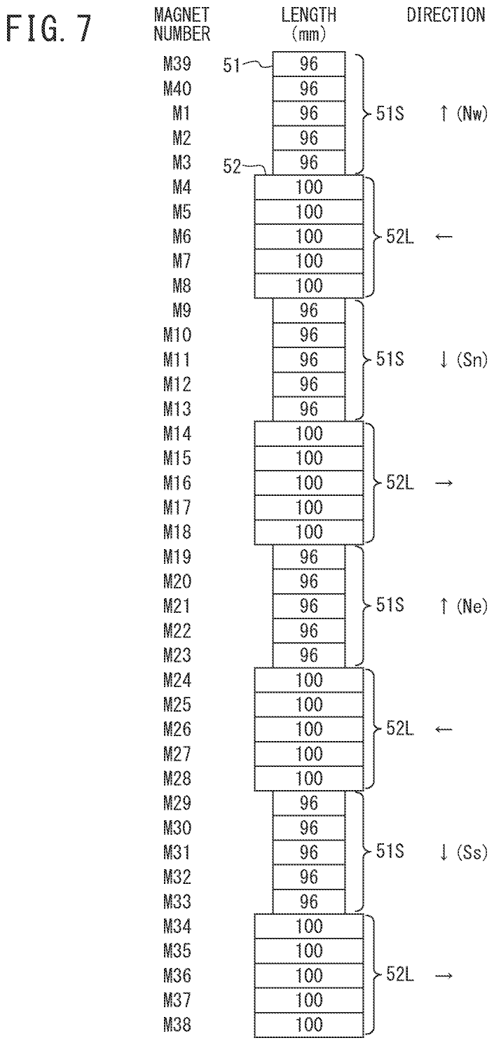

More specifically, in the field element 2 of the present embodiment, as first magnets 51 constituting the first groups 51S among the unit permanent magnets 50, magnets the axial length of which is shorter than that of second magnets 52 constituting the second groups 52L are used, as illustrated in a schematic developed view in FIG. 7. In the present embodiment, the axial length of the first magnets 51 constituting the first groups 51S is 96 mm, and the axial length of the second magnets 52 constituting the second groups 52L is 100 mm.

Because of this configuration, in the present embodiment, the field element 2 has, with respect to all of the plurality of unit permanent magnets 50, the first groups 51S each of which includes a plurality of first magnets 51 that are arranged adjacent to one another and the second groups 52L each of which includes a plurality of second magnets 52 that are unit permanent magnets 50 other than unit permanent magnets 50 included in the first groups 51S and are arranged adjacent to one another, and the first magnets 51 constituting the first groups 51S are formed of unit permanent magnets 50 repelling each other and the second magnets 52 constituting the second groups 52L are formed of unit permanent magnets 50 attracting each other.

In the present embodiment, the plurality of unit permanent magnets 50 include as many unit permanent magnets as a number obtained by multiplying the number P (P is a positive integer) of pole pairs constituting the Halbach array by 20, and each first group 51S includes five unit permanent magnets 50 that are arranged adjacent to one another and repel each other, each second group 52L includes five unit permanent magnets that are arranged adjacent to one another and attract each other, and the first groups 51S and the second groups 52L are alternately arranged in the circumferential direction.

Since, in the present embodiment, the plurality of unit permanent magnets 50 include 40 permanent magnets that constitute a quadrupole Halbach array as described above, the first groups 51S and the second groups 52L have portions thereof adjacent to each other displaced forward and backward in the axial direction with respect to each other and recessed step portions D are thereby formed at four locations separated from each other in the circumferential direction on the axial end surfaces of the field element 2.

As illustrated in FIG. 7, each of the first groups 51S includes five permanent magnets that are arranged adjacent to one another with a unit permanent magnet positioned at one of M1, M11, M21, and M31 as the center and that repel each other. In addition, each of the second groups 52L includes five permanent magnets that are unit permanent magnets 50 constituting a transition region between poles adjacent to each other and arranged adjacent to one another and that attract each other. The first groups 51S and the second groups 52L are alternately arranged in the circumferential direction.

As described above, in the present embodiment, attraction groups and repulsion groups are defined based on the first groups 51S and the second groups 52L each of which bundles a plurality of unit permanent magnets 50 adjacent to one another by focusing on existence or nonexistence of attractive force between unit permanent magnets 50 that are arranged adjacent to each other.

In the present embodiment, by alternately arranging on circumferential direction the first groups 51S and the second groups 52L, which are sets of five unit permanent magnets 50 the lengths of which are different between the first groups 51S and the second groups 52L, level differences for torque transmission are formed on the end surfaces of the field element 2.

However, as a method for forming level differences on the end surfaces of the field element 2, the lengths of the unit permanent magnets 50 may be differentiated as described in the present embodiment, and, without being limited thereto, even when the unit permanent magnets 50 of the same length are used, the unit permanent magnets 50 may be displaced forward and backward from each other in the axial direction with respect to each other.

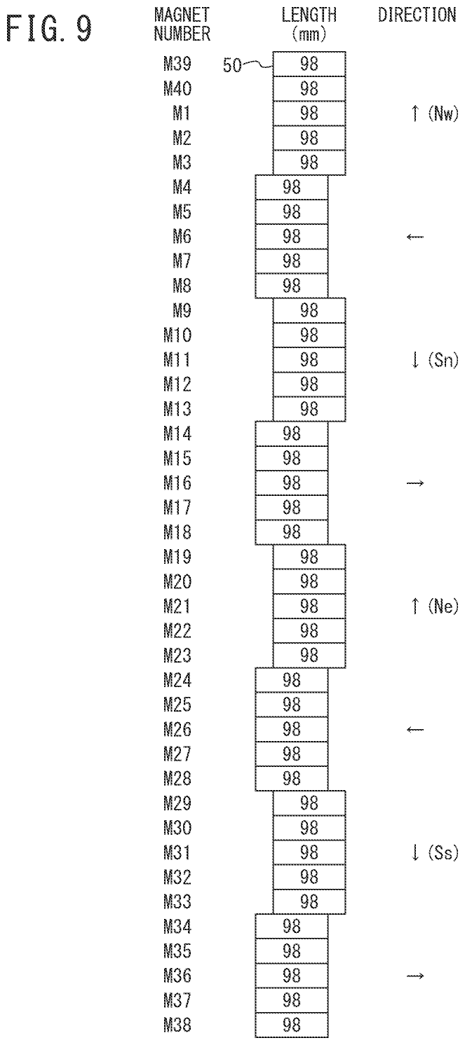

In other words, although the recessed step portions D of the present embodiment are formed by the plurality of unit permanent magnets 50 including the first magnets 51 and the second magnets 52 the axial length of which is shorter than that of the first magnets 51, the present invention is not limited thereto. For example, another example is illustrated in FIG. 9. In the drawing, as the plurality of unit permanent magnets 50, the first magnets and the second magnets the axial lengths of which are set to the same length (in the example in the drawing, 98 mm) are used.

In this case, as schematically illustrated in the drawing, displacing the axial positions of the first magnets and the second magnets forward and backward with respect to each other enables recessed step portions and protruding step portions to be formed on the axial end surfaces. Because of this configuration, when recessed portions or protruding portions that are arranged opposite to the step portions in the axial direction are disposed, torque can be transmitted through fitting between the step portions and the recessed portions or the protruding portions.

When a division number for defining the attraction groups and the repulsion groups using the unit permanent magnets 50 is set, the division number can be set as the number of poles multiplied by 2. Since the present embodiment is an example of division into fortieths and 4 poles multiplied by 2 is equal to 8 (division into eighths), one set of a plurality of unit permanent magnets 50 includes five unit permanent magnets 50.

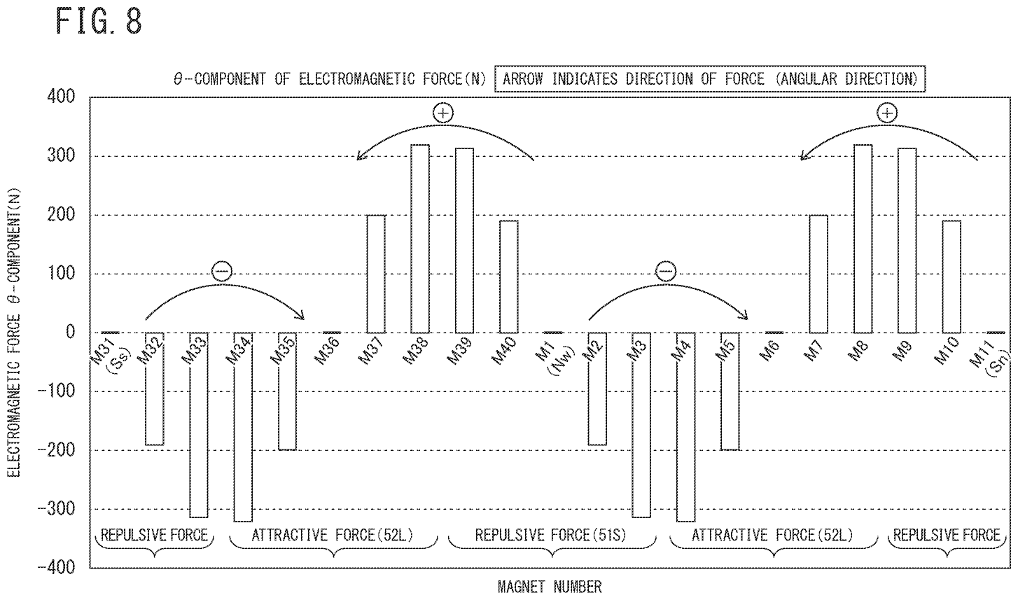

Since the present embodiment is an example of four poles and division into fortieths, when magnet numbers of unit permanent magnets at respective division positions are sequentially denoted by M1 to M40 as illustrated in FIGS. 5A and 5B, the attraction groups and the repulsion groups can be defined by dividing the unit permanent magnets into eighths using sets of unit permanent magnets each of which includes unit permanent magnets within an angle of 45 degrees. A simulation result using the finite element method is illustrated in Table 1 and FIG. 8. Note that, since the result is bilaterally symmetric, a portion on one side that is divided into twentieths is illustrated in Table 1 and FIG. 8 and illustration and description of the opposite side will be appropriately omitted.

TABLE 1

| | θ-Component of | Attractive Force (+) |
|---|---|---|
| Magnet | Electromagnetic Force | and Repulsive Force |
| Number | (N) | (−) inside Set |
| M31 | 0 | − |
| M32 | −192 | −192 |
| M33 | −314 | −123 |
| M34 | −321 | 119 |
| M35 | −201 | 202 |
| M36 | 0 | + |
| M37 | 201 | 200 |
| M38 | 320 | 119 |
| M39 | 314 | −122 |
| M40 | 192 | −192 |
| M1 | 0 | − |
| M2 | −193 | −193 |
| M3 | −314 | −121 |
| M4 | −320 | 120 |
| M5 | −200 | 200 |
| M6 | 0 | + |
| M7 | 201 | 201 |
| M8 | 320 | 119 |
| M9 | 314 | −124 |
| M10 | 191 | −191 |
| M11 | 0 | − |

In FIG. 8, a result of calculation of the θ-component (circumferential direction component) of electromagnetic force exerted on each unit permanent magnet 50 using the finite element method is illustrated. When the drawing is illustrated, a cylindrical coordinate is defined, and, regarding the coordinate axes, the rotational axis of the shaft 10 is defined as the Z-axis, the radial direction is defined as the R-axis, and the angular θ component in the left rotation direction in the circumferential direction when viewed from the upper side of the rotational axis is defined as the + direction of an arrow.

As illustrated in the drawing, the θ-components of electromagnetic force exerted on the respective unit permanent magnets 50 include, in sequence starting from the left side of the drawing, the angular θ components of electromagnetic force having values in the − direction at the magnet numbers M32 to M35, the angular θ components of electromagnetic force having values in the + direction at the magnet numbers M37 to M40, the angular θ components of electromagnetic force having values in the − direction at the magnet numbers M2 to M5, and the angular θ components of electromagnetic force having values in the + direction at the magnet numbers M7 to M10.

As illustrated in FIG. 8, attractive force is exerted at positions at which arrows indicating the directions of angular θ components oppose each other, and repulsive force is exerted at positions at which arrows indicating the directions of angular θ components point in the opposite directions. Thus, a set of in total five unit permanent magnets 50 with the magnet numbers M34 to M38 that includes a unit permanent magnet 50 with the magnet number M36 located at a position at which electromagnetic force is zero as the center and two unit permanent magnets 50 preceding the center unit permanent magnet 50 and two unit permanent magnets 50 succeeding the center unit permanent magnet 50 is defined as an attraction group 52L in which the unit permanent magnets 50 attract each other.

Likewise, a set of in total five unit permanent magnets 50 with the magnet numbers M39 to M3 that includes a unit permanent magnet 50 with the magnet number M1 located at a position at which electromagnetic force is zero as the center and two unit permanent magnets 50 preceding the center unit permanent magnet 50 and two unit permanent magnets 50 succeeding the center unit permanent magnet 50 is defined as a repulsion group 51S in which the unit permanent magnets 50 repel each other.

As described above, in a portion around a unit permanent magnet 50 magnetized to each pole, such as the unit permanent magnets 50 with the magnet numbers M1 (Nw) and M11 (Sn), adjacent unit permanent magnets 50 repel each other, and, in a transition region between different poles, such as a region between the unit permanent magnets 50 with the magnetic numbers M31 and M11, attractive force is exerted on adjacent unit permanent magnets 50. Thus, the torque transmission teeth 60 are preferably engaged with the sets of unit permanent magnets 50 constituting the transition regions between the poles, as described in the present embodiment.

As illustrated in FIG. 6, the teeth 60 at four locations are fitted into the recessed portions D at four locations on one side of the cylindrical field element 2 at alternate positions in the circumferential direction by arranging the protruding portion of the teeth 60 at positions each of which is opposed to one of the recessed portions D. In other words, in the present embodiment, the teeth 60 are fitted into the recessed portions D at eight locations in total on both axial sides of the field element 2.

In particular, the coupling structure of the present embodiment is configured such that, at the time of coupling and decoupling of the coupling structure, the coupling and decoupling can be easily performed by simply moving the pair of field element end holders 6 in the axial direction of the field element 2. Shading illustrations illustrated in FIG. 5B indicate an image in which the recessed portions D are formed at four locations (the same applies to Table 1).

Note that, since each unit permanent magnet 50 is a permanent magnet having strong magnetic force, such as a neodymium magnet, the unit permanent magnet 50 is likely to be mechanically broken. In addition, shearing force is exerted on an end portion of a unit permanent magnet 50 that comes into contact with each tooth 60 in the circumferential direction. Therefore, the amount of forward and backward displacement in the axial direction between adjacent unit permanent magnets (in other words, depth of each recessed portion D) is preferably 3 mm or less, and is, as illustrated in FIG. 7 in the present embodiment, set to 2 mm ((100 mm−96 mm)/2) on one side of the field element 2.

Next, operation and advantageous effects of the Halbach motor 1 of the present embodiment will be described.

In the Halbach motor 1 of the present embodiment, NS magnetic fields of the quadrupole field element 2 being attracted to moving magnetic field that is generated by respectively applying three phases of three-phase AC to winding end terminals of the respective armature windings 30 and flowing in sequence the U-phase, V-phase, and W-phase AC currents that are temporally delayed from one another by 120° to the three armature windings 30 causes the field element 2 to synchronize with the three-phase AC current and thereby enables the Halbach motor 1 to rotate at a rotation speed matching the frequency of the three-phase AC current.

Although various methods for fixing unit permanent magnets to a rotor are conceivable, a method that enables torque to be securely transmitted to the shaft of a rotor having a Halbach field element with a simple structure is expected.

In response, according to the rotor having the field element 2 and the Halbach motor 1 including the rotor of the present embodiment, since the rotor includes a coupling structure to transmit rotational torque of the field element 2 to the shaft 10 as described above, it becomes possible to securely transmit torque to the shaft 10 with a simple structure.

In particular, since the coupling structure is configured including the plurality of recessed portions D that are formed by adjacent groups of a plurality of unit permanent magnets 50 in the Halbach array being displaced forward and backward in the axial direction with respect to each other and the teeth 60 that form a plurality of protruding portions arranged opposite to the plurality of recessed portions D in the axial direction and is configured to transmit rotational torque through fitting between the plurality of recessed portions D and the plurality of teeth 60, the coupling structure excels as a configuration that enables torque to be securely transmitted with a simple structure.

Further, according to the field element 2, the rotor having the field element 2, and the Halbach motor 1 including the rotor according to the present embodiment, since a torque transmission mechanism is configured by fitting the protruding portions of the teeth 60 that form torque transmission means into the recessed portions D that are formed on the end surfaces of the field element 2 by dividing the unit permanent magnets 50 into the attraction groups 52L of unit permanent magnets 50 attracting each other and the repulsion groups 51S of unit permanent magnets 50 repelling each other and displacing groups of unit permanent magnets 50 in the attraction groups 52L and groups of unit permanent magnets 50 in the repulsion groups 51S forward and backward in the axial direction with respect to each other, it is possible to effectively transmit rotational torque with a simple configuration, and, since the attraction groups 52L in each of which unit permanent magnets 50 firmly adhering to each other and attracting each other are bundled transmit torque, even a neodymium magnet that is likely to be mechanically broken can ensure a high mechanical torque transmission performance.

Note that the coupling structure of the field element according to the present invention is not limited to the above-described embodiment and it is needless to say that various modifications can be made without departing from the spirit and scope of the present invention.

For example, although the above-described embodiment was described using an example in which, when a coupling structure is configured, the recessed portions D are formed in the axial direction between adjacent sets of unit permanent magnets 50 with respect to all the unit permanent magnets 50 constituting the Halbach field element 2, the present invention is not limited to the example, and the recessed portions D formed by adjacent sets of unit permanent magnets 50 being displace forward and backward in the axial direction with respect to each other may be formed with respect to at least some of pairs of adjacent sets of unit permanent magnets 50. In this case, it is preferable to dispose a plurality of recessed portions D in such a way that the plurality of recessed portions D are arranged at equal intervals on circumferential direction.

In addition, although the above-described embodiment was described using a single Halbach motor 1 that includes a rotor having one field element 2 as an example, the present invention is not limited to the example, and the present invention is applicable to a dual Halbach motor in which an inner field element and an outer field element rotate on the outer side and the inner side of a coil, respectively, at the same time.

In other words, the Halbach motor can be configured to include a rotor having a field element that is configured including a structure in which a plurality of unit permanent magnets are arranged in a cylindrical shape, an armature arranged in such a manner as to surround the circumference of the rotor, and a housing configured to house the rotor and the armature and to further include, as another rotor, a second rotor arranged in such a manner as to surround the circumference of the armature.

In addition, although, in the above-described embodiment, an example in which a form of fitting through which torque is transmitted in the coupling structure is formed by a recessed step portion D on the field element 2 side and a tooth 60 forming a protruding portion on the field element end holder 6 side was described, the present invention is not limited to the example, and it is possible to configure the coupling structure to transmit torque by fitting a protruding step portion on the field element 2 side and a recessed portion on the field element end holder 6 side to each other.

### Another Embodiment

Next, a Halbach field element 2 of another embodiment and a rotor including this Halbach field element 2 will be described in more detail. However, the same constituent components as or corresponding constituent components to those in the above-described embodiment are designated by the same reference signs and description thereof will be appropriately omitted.

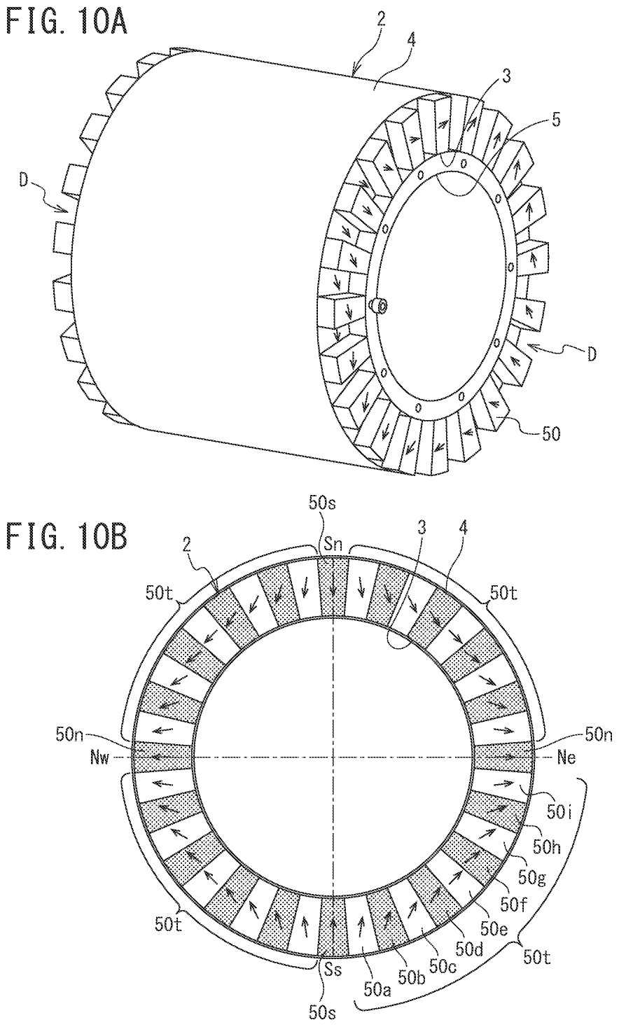

The field element 2 of the another embodiment is a field element that has a quadrupole NS magnetic field structure in which a plurality of (in this example, 40) unit permanent magnets 50 are combined in the circumferential direction into a cylindrical shape and are arranged in a Halbach array, as illustrated in FIGS. 10A and 10B.

When the rotor is configured, the above-described shaft 10 is arranged at the center of the field element 2 along the axial direction. Note that, as with the above-described embodiment, when a plurality of unit permanent magnets are referred to without distinguishing the unit permanent magnets from one another, the plurality of unit permanent magnets are denoted by a representative reference sign 50, as illustrated in FIG. 10A.

The plurality of unit permanent magnets 50 the magnetic directions of which are differentiated between unit permanent magnets 50 adjacent to each other are combined in such a way as to be arranged in a predetermined Halbach array. Note that, in the drawing, an arrow illustrated on an end surface of each unit permanent magnet 50 indicates an image of a magnetic direction that the unit permanent magnet 50 has and the base end side and the tip end side of the arrow are the S-pole and the N-pole, respectively.

In the Halbach array, it is preferable that, for example, any one of numbers each of which is obtained by adding 2 to a multiple of 3 be defined as a division number for dividing one cycle of electrical angle and unit permanent magnets 50 the magnetization directions of which are successively changed by an angle obtained by dividing one cycle of electrical angle by the division number be arranged, as illustrated in FIG. 10B. In this case, cross-sectional shapes parallel with all the magnetization directions of the unit permanent magnets 50 are the same.

In the Halbach field element 2 of the another embodiment, as with the above-described embodiment, two unit permanent magnets 50s are arranged as unit permanent magnets for S-pole portions, two unit permanent magnets 50n are arranged as unit permanent magnets for N-pole portions, and four sets of unit permanent magnets each of which includes nine types of unit permanent magnets 50a to 50i are respectively arranged in four Halbach transition portions 50t. For this reason, to assemble one field element 2, 40 unit permanent magnets 50 of eleven types in total are required.

In other words, in the another embodiment, since the cross-sectional shapes parallel with all the magnetization directions of the unit permanent magnets 50 are the same, the Halbach array of the Halbach field element 2 is configured by a set of 40 unit permanent magnets 50 the magnetization directions of which are successively changed by 18°.

The rotor of the another embodiment includes a coupling structure to transmit rotational torque of the field element 2 to the above-described shaft 10.

The coupling structure of the another embodiment includes a plurality of recessed portions D that are formed by at least some of pairs of adjacent unit permanent magnets 50 being displaced forward and backward in the axial direction with respect to each other and teeth 60 that form a plurality of protruding portions arranged opposite to the plurality of recessed portions D in the axial direction and is configured to transmit torque through fitting between the plurality of recessed portions D and the plurality of teeth 60.

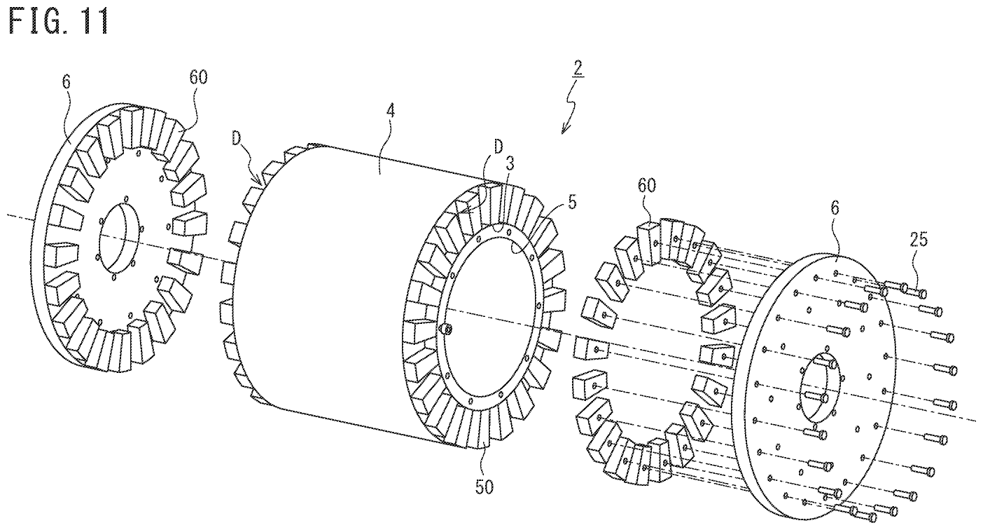

Specifically, as illustrated in an exploded perspective view in FIG. 11, the rotor of the another embodiment includes, as a plurality of protruding portions, the plurality of teeth 60 that are fitted into the plurality of recessed portions D of the plurality of unit permanent magnets 50 constituting the coupling structure.

Each tooth 60 is made of a non-magnetic material (for example, made of stainless steel), and the plan-view shape of the tooth 60 is a similar figure to the end surface of a unit permanent magnet 50. In the rotor of the another embodiment, on the axially inner side surfaces of a pair of field element end holders 6, the plurality of teeth 60 are fixed by tooth fixing bolts 25.

Note that, for each tooth 60, various types of non-magnetic materials without being limited to stainless steel can be employed. Plastics may be employed. It is suitable to use lightweight aluminum alloy or plastics as a material of each tooth 60 in order to configure a lightweight, low-inertia rotor.

In particular, in the another embodiment, alternately displacing adjacent unit permanent magnets 50 forward and backward in the axial direction with respect to each other with respect to all the plurality of unit permanent magnets 50 causes recessed portions D to be formed at 20 locations. Protruding portions at 20 locations are arranged at positions opposed to the recessed portions D at the 20 locations using the teeth 60 and are fitted into the recessed portions D at the 20 locations at alternate positions.

In other words, in the another embodiment, the teeth 60 are fitted into the recessed portions D at 40 locations in total on both axial sides of the field element 2. The coupling structure of the another embodiment is configured such that, at the time of coupling and decoupling of the coupling structure, the coupling and decoupling can be easily performed by simply moving the pair of field element end holders 6 in the axial direction of the field element 2. Note that shading illustrations illustrated in FIG. 10B indicate an image in which the recessed portions D are formed at 20 locations.

Note that, since each unit permanent magnet 50 is a permanent magnet having strong magnetic force, such as a neodymium magnet, the unit permanent magnet 50 is likely to be mechanically broken. In addition, shearing force is exerted on an end portion of a unit permanent magnet 50 that comes into contact with each tooth 60 in the circumferential direction. Therefore, the amount of forward and backward displacement in the axial direction between adjacent unit permanent magnets (in other words, depth of each recessed portion D) is preferably 3 mm or less, and is, in the another embodiment, set to 2 mm.

As described above, according to the rotor 2 and the Halbach motor 1 including the rotor 2 of the another embodiment, since the rotor 2 includes a coupling structure to transmit rotational torque of the field element 2 to the shaft 10, it becomes possible to securely transmit torque to the shaft 10 with a simple structure.

In particular, since the coupling structure of the another embodiment is configured including the plurality of recessed portions D that are formed by adjacent unit permanent magnets 50 in the Halbach array being displaced forward and backward in the axial direction with respect to each other and the teeth 60 that form a plurality of protruding portions arranged opposite to the plurality of recessed portions D in the axial direction and is configured to transmit rotational torque through fitting between the plurality of recessed portions D and the plurality of teeth 60, the coupling structure excels as a configuration that enables torque to be securely transmitted with a simple structure.

Note that the coupling structure of the field element according to the present invention is not limited to the above-described embodiment and another embodiment and it is needless to say that various modifications can be made without departing from the spirit and scope of the present invention.

For example, although the another embodiment was described using an example in which, when a coupling structure is configured, the plurality of recessed portions D are formed by displacing adjacent unit permanent magnets 50 forward and backward in the axial direction with respect to each other with respect to all the unit permanent magnets 50 constituting the Halbach field element 2, the present invention is not limited to the example, and the recessed portions D may be formed by displacing at least some of pairs of adjacent unit permanent magnets 50 forward and backward in the axial direction with respect to each other. In this case, it is preferable to dispose a plurality of recessed portions D in such a way that the plurality of recessed portions D are arranged at equal intervals.

### REFERENCE SIGNS LIST

1 Halbach motor (rotary electrical machine)
2 Halbach field element
3 Field element inner holder (inner cylinder)
4 Field element outer holder (outer cylinder)
5 Inner yoke
6 Field element end holder (end face cover, hub, or wheel)
7 Yoke
8 Yoke presser
9 Outer yoke
10 Shaft
11 Shaft flange
12 Coil holder
14 Coil holder cover
15 Front housing
16 Rear housing
17 Base
20 Bearing
21 C-type retaining ring
22 Holder fixing bolt
23 Yoke fixing bolt
24 Housing fixing bolt
25 Tooth fixing bolt
30 Armature winding
31 Coil end (front)
32 Coil side
33 Coil end (rear)
50 Unit permanent magnet
51 First magnet
51S First group (repulsion group)
52 Second magnet
52L Second group (attraction group)
60 Tooth (protruding portion)
D Recessed portion of a coupling structure
M1 to M40 Magnet number (of each unit permanent magnet)

1. A field element comprising
a plurality of unit permanent magnets arranged in a cylindrical shape in a circumferential direction to form a Halbach array,
wherein the plurality of unit permanent magnets include a first group including a plurality of the unit permanent magnets arranged adjacent to one another and a second group including a plurality of the unit permanent magnets, the unit permanent magnets being the unit permanent magnets other than the first group and being arranged adjacent to one another,
first magnets constituting the first group are formed of unit permanent magnets repelling each other,
second magnets constituting the second group are formed of unit permanent magnets attracting each other, and
the first group and the second group are displaced forward and backward in an axial direction with respect to each other and a step portion is formed on an axial end surface of the first group and the second group.

2. The field element according to claim 1, wherein the step portion is formed by the plurality of unit permanent magnets including the first magnets and the second magnets having axial length shorter than length of the first magnets.

3. The field element according to claim 1, wherein the step portion is formed by displacing axial positions of the first magnets and the second magnets of the plurality of unit permanent magnets forward and backward in the axial direction with respect to each other.

4. The field element according to claim 1, wherein
the plurality of unit permanent magnets include as many unit permanent magnets as a number obtained by multiplying a number P (P is a positive integer) of pole pairs constituting a Halbach array by 20,
each of the first groups includes five unit permanent magnets arranged adjacent to one another and attracting each other,
each of the second groups includes five unit permanent magnets arranged adjacent to one another and repelling each other, and
the first groups and the second groups are alternately arranged in a circumferential direction.

5. A rotor comprising:
the field element according to claim 1; a shaft arranged at a center of the field element along an axial direction; and a coupling structure configured to transmit rotational torque of the field element to the shaft,
wherein the coupling structure includes a plurality of recessed step portions formed by the first groups and the second groups of the plurality of unit permanent magnets being displaced forward and backward in an axial direction with respect to each other and a plurality of protruding portions arranged opposite to the plurality of recessed step portions in the axial direction and transmits the torque through fitting between the plurality of recessed step portions and the plurality of protruding portions.

6. The rotor according to claim 5 comprising:
a pair of disk-shaped field element end holders mounted on both axial ends of a plurality of unit permanent magnets arranged in the cylindrical shape; and a plurality of teeth fitting into recessed step portions on end surfaces of the plurality of unit permanent magnets, the unit permanent magnets constituting the coupling structure, as the plurality of protruding portions,
wherein the shaft is disposed at a central portion of the pair of field element end holders in such a manner as to penetrate the pair of field element end holders in the axial direction, and
the plurality of teeth are fixed on an inner side surface in the axial direction of each field element end holder.

7. The rotor according to claim 6, wherein the teeth are made of a non-magnetic material and a plan-view shape of the teeth is a similar figure to a shape of a recessed step portion formed by end surfaces of the plurality of unit permanent magnets.

8. The rotor according to claim 5, wherein
the field element includes the plurality of unit permanent magnets arranged in a cylindrical shape while forming a Halbach array and a magnet holder configured to house and hold the plurality of unit permanent magnets,
the magnet holder includes a holder inner cylinder and a holder outer cylinder forming hollow cylindrical shapes and made of a non-magnetic material, and
the plurality of unit permanent magnets arranged in the cylindrical shape are arranged in a coaxial manner with the holder inner cylinder and the holder outer cylinder and are bound in a space between the opposing holder inner cylinder and holder outer cylinder arranged in a coaxial manner.

9. The rotor according to claim 8, wherein each of the unit permanent magnets has a hexahedral shape in which two surfaces at both axial ends are shaped in rectangles, sectors, or shapes formed by combining a rectangle and a sector parallel and congruent with each other and the other four surfaces extending in the axial direction are formed in flat surfaces or curved surfaces extending along opposing outlines of the two surfaces at both axial ends.

10. A rotary electrical machine comprising:
a rotor including a field element configured including a structure in which a plurality of unit permanent magnets are arranged in a cylindrical shape; an armature arranged in such a manner as to surround a circumference of the rotor; and a housing configured to house the rotor and the armature,
wherein the rotary electrical machine includes, as the rotor, the rotor according to claim 5.

11. The rotary electrical machine according to claim 10 further comprising
as the rotor, a second rotor arranged in such a manner as to surround a circumference of the armature.

12. A field element comprising
a plurality of unit permanent magnets arranged in a cylindrical shape in a circumferential direction,
wherein at least some of pairs of the unit permanent magnets adjacent to each other are arranged in such a manner as to be displaced forward and backward in an axial direction with respect to each other.

13. A rotor comprising:
a field element including a plurality of unit permanent magnets arranged in a cylindrical shape in a circumferential direction; a shaft arranged at a center of the field element along an axial direction; and a coupling structure configured to transmit rotational torque of the field element to the shaft,
wherein the coupling structure includes a plurality of recessed portions formed by at least some of pairs of the unit permanent magnets adjacent to each other being arranged in such a manner as to be displaced forward and backward in the axial direction with respect to each other and a plurality of protruding portions arranged opposite to the plurality of recessed portions in the axial direction and transmits the torque through fitting between the plurality of recessed portions and the plurality of protruding portions.

14. The rotor according to claim 13 comprising:
a pair of disk-shaped field element end holders mounted on both axial sides of a plurality of unit permanent magnets arranged in the cylindrical shape; and, as the plurality of protruding portions, a plurality of teeth fitting into recessed portions of the plurality of unit permanent magnets constituting the coupling structure,
wherein the shaft is disposed at a central portion of the pair of field element end holders in such a manner as to penetrate the pair of field element end holders in the axial direction, and
the plurality of teeth are fixed on an inner side surface in the axial direction of each field element end holder.

15. The rotor according to claim 14, wherein the teeth are made of a non-magnetic material and a plan-view shape of each of the teeth is a similar figure to a shape of an end surface of the unit permanent magnet.

16. The rotor according to claim 13, wherein
the field element includes the plurality of unit permanent magnets arranged in a cylindrical shape while forming a Halbach array and a magnet holder configured to house and hold the plurality of unit permanent magnets,
the magnet holder includes a holder inner cylinder and a holder outer cylinder forming hollow cylindrical shapes and made of a non-magnetic material, and
the plurality of unit permanent magnets arranged in the cylindrical shape are arranged in a coaxial manner with the holder inner cylinder and the holder outer cylinder and are bound in a space between the opposing holder inner cylinder and holder outer cylinder arranged in a coaxial manner.

17. The rotor according to claim 16, wherein each of the unit permanent magnets has a hexahedral shape in which two surfaces at both axial ends are shaped in rectangles, sectors, or shapes formed by combining a rectangle and a sector parallel and congruent with each other and the other four surfaces extending in the axial direction are formed in flat surfaces or curved surfaces extending along opposing outlines of the two surfaces at both axial ends.

18. A rotary electrical machine comprising:
a rotor including a field element configured including a structure in which a plurality of unit permanent magnets are arranged in a cylindrical shape; an armature arranged in such a manner as to surround a circumference of the rotor; and a housing configured to house the rotor and the armature,
wherein the rotary electrical machine includes, as the rotor, the rotor according to claim 13.
